(19) United States
(12) Patent Application Publication
(10) Pub. No.: US 2024/0343017 A1
(43) Pub. Date: Oct. 17, 2024

(54) CARBON FIBER COMPONENT BASED ELECTRIC VEHICLES

(71) Applicant: Haze Automotive of America, Inc., Northbrook, IL (US)

(72) Inventors: Sean Mario Hazaray, Northbrook, IL (US); Ramino Troy Beetz, Rancho Palos Verdes, CA (US)

(73) Assignee: Haze Automotive of America, Inc., Northbrook, IL (US)

(21) Appl. No.: 18/294,295

(22) PCT Filed: Aug. 1, 2022
(86) PCT No.: PCT/US2022/039075

§ 371 Date: Feb. 1, 2024

Related U.S. Application Data
(60) Provisional application No. 63/228,475, filed on Aug. 2, 2021.

(51) Int. Cl. B32B 5/26; B32B 3/12; B32B 5/02; B32B 15/14; B32B 15/20; B33Y 10/00; B33Y 80/00

(52) U.S. Cl. CPC B32B 5/26; B32B 3/12; B32B 5/02; B32B 15/14; B32B 15/20; B32B 2255/02; B32B 2255/06; B32B 2255/26; B32B 2260/023; B32B 2260/046; B32B 2262/0261; B32B 2262/106; B32B 2262/14; B32B 2307/302; B32B 2307/7376; B32B 2605/08; B33Y 10/00; B33Y 80/00

(57) ABSTRACT

Systems and methods herein are directed to a tub of an electric vehicle. The tub can include a composite structure formed at least partially by additive manufacturing. The composite structure of the tub can include one or more carbon-fiber layers. The composite structure of the tub can include a nomex honeycomb layer. The composite structure of the tub can include one or more layers of epoxy. The tub can include a thermal management assembly formed with the composite structure. The tub can include a wire harness, sensor, or battery formed with the composite structure.

### CROSS-REFERENCE TO RELATED APPLICATIONS

The present application claims the benefit of and priority to U.S. Provisional Application No. 63/228,475, filed Aug. 2, 2021, the disclosure of which is incorporated herein by reference in its entirety.

### BACKGROUND

Electric vehicles can include a body having a finite mass. The electric vehicle can contain occupants of the vehicle, an electric battery, or other various components.

### SUMMARY

At least one aspect is directed to a tub of an electric vehicle. The tub can include a composite structure. The composite structure can include a shell formed at least partially by additive manufacturing. The composite structure of the tub can include one or more carbon-fiber layers. The composite structure of the tub can include a nomex honeycomb layer. The composite structure of the tub can include one or more layers of epoxy.

At least one aspect is directed to a method. The method can include forming a carbon-fiber nylon filament shell. The method can include applying a first carbon fiber layer to the shell. The method can include applying a first layer of an epoxy material. The method can include applying a nomex honeycomb material to the shell. The method can include applying a second layer of an epoxy material. The method can include applying a second carbon fiber layer to the shell.

At least one aspect is directed to an electric vehicle. The electric vehicle can include a tub. The tub can include a composite structure. The composite structure can include a shell formed at least partially by additive manufacturing. The composite structure of the tub can include one or more carbon-fiber layers. The composite structure of the tub can include a nomex honeycomb layer. The composite structure of the tub can include one or more layers of epoxy.

At least one aspect is directed to a tub of an electric vehicle. The tub can include a thermal management assembly formed with the tub. The thermal management assembly can include a thermal conductive layer. The thermal management assembly can include one or more carbon-fiber shields. The thermal management assembly can include one or more layers of epoxy. The thermal management assembly can facilitate regulating temperature of a battery.

At least one aspect is directed to a method. The method can include forming a carbon-fiber nylon filament shield. The method can include applying, to the carbon-fiber nylon filament shield, a thermal conductive layer. The method can include applying, to the thermal conductive layer, an epoxy layer. The method can include applying, to the epoxy layer, a second carbon-fiber nylon filament shield.

At least one aspect is directed to an electric vehicle. The electric vehicle can include a tub. The tub can include a thermal management assembly formed with the tub. The thermal management assembly can include a thermal conductive layer. The thermal management assembly can include one or more carbon-fiber shields. The thermal management assembly can include one or more layers of epoxy. The thermal management assembly can facilitate regulating temperature of a battery.

At least one aspect is directed to a tub of an electric vehicle. The tub can include an energy-absorbing impact assembly formed with the tub. The energy-absorbing impact assembly can include a matrix material structure. The matrix material structure can include a honeycomb material. The energy-absorbing impact assembly can facilitate absorbing the energy and force of an impact to the electric vehicle.

At least one aspect is directed to a method. The method can include forming a composite structure including a carbon-fiber nylon filament portion. The method can include forming, with the composite structure, a matrix including a honeycomb material.

At least one aspect is directed to an electric vehicle. The electric vehicle can include a tub. The tub can include an energy-absorbing impact assembly formed with the tub. The energy-absorbing impact assembly can include a matrix material structure. The matrix material structure can include a honeycomb material. The energy-absorbing impact assembly can facilitate absorbing the energy and force of an impact to the electric vehicle.

At least one aspect is directed to a tub of an electric vehicle. The tub can include a composite structure having a shell. The shell can include at least one portion of a carbon-fiber nylon filament. The composite structure can include a portion of a wire harness formed with a portion of the shell.

At least one aspect is directed to a method. The method can include forming a shell including at least one portion of a carbon-fiber nylon filament. The method can include forming, with the shell, a portion of a wire harness assembly.

At least one aspect is directed to an electric vehicle. The electric vehicle can include a tub. The tub can include a composite structure having a shell. The shell can include at least one portion of a carbon-fiber nylon filament. The composite structure can include a portion of a wire harness formed with a portion of the shell.

At least one aspect is directed to a tub of an electric vehicle. The tub can include a composite structure having a shell. The shell can include at least one portion of a carbon-fiber nylon filament. The composite structure can include a portion of a battery formed with a portion of the composite structure.

At least one aspect is directed to a method. The method can include forming a shell including at least one portion of a carbon-fiber nylon filament. The method can include forming, with the shell, a cell membrane. The method can include enclosing, within the cell membrane, a battery cell.

At least one aspect is directed to an electric vehicle. The electric vehicle can include a tub. The tub can include a composite structure having a shell. The shell can include at least one portion of a carbon-fiber nylon filament. The composite structure can include a portion of a battery formed with a portion of the composite structure.

At least one aspect is directed to a tub of an electric vehicle. The tub can include a composite structure having a shell. The shell can include at least one portion of a carbon-fiber nylon filament. The composite structure can include a sensor formed with a portion of the shell.

At least one aspect is directed to a method. The method can include forming a shell including at least one portion of a carbon-fiber nylon filament. The method can include forming, with the shell, a sensor.

At least one aspect is directed to an electric vehicle. The electric vehicle can include a tub. The tub can include a composite structure having a shell. The shell can include at least one portion of a carbon-fiber nylon filament. The composite structure can include a sensor formed with a portion of the shell.

At least one aspect is directed to a tub of an electric vehicle. The tub can include a composite structure having a shell. The shell can include at least one portion of a carbon-fiber nylon filament. The composite structure can include a LIDAR sensor formed with a portion of the shell.

At least one aspect is directed to a method. The method can include forming a shell including at least one portion of a carbon-fiber nylon filament. The method can include forming, with the shell, a LIDAR sensor.

At least one aspect is directed to an electric vehicle. The electric vehicle can include a tub. The tub can include a composite structure having a shell. The shell can include at least one portion of a carbon-fiber nylon filament. The composite structure can include a LIDAR sensor formed with a portion of the shell.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIG. 1 depicts a side view of a schematic of an electric vehicle, according to an exemplary implementation.

FIG. 2 depicts a perspective view of a portion of the electric vehicle of FIG. 1, according to an exemplary implementation.

FIG. 3 depicts a perspective view of a portion of the electric vehicle of FIG. 1, according to an exemplary implementation.

FIG. 4 depicts an illustration of a process of providing a portion of an electric vehicle, according to an exemplary implementation.

FIG. 5 depicts a perspective view of a portion of the electric vehicle of FIG. 1, according to an exemplary implementation.

FIG. 6 depicts a side view of a portion of the electric vehicle of FIG. 1, according to an exemplary implementation.

FIG. 7 depicts an illustration of a process of providing a portion of an electric vehicle, according to an exemplary implementation.

FIG. 8 depicts a perspective view of a portion of the electric vehicle of FIG. 1, according to an exemplary implementation.

FIG. 9 depicts an illustration of a process of providing a portion of an electric vehicle, according to an exemplary implementation.

FIG. 10 depicts a side view of a portion of the electric vehicle of FIG. 1, according to an exemplary implementation.

FIG. 11 depicts an illustration of a process of providing a portion of an electric vehicle, according to an exemplary implementation.

FIG. 12 depicts a perspective view of a portion of the electric vehicle of FIG. 1, according to an exemplary implementation.

FIG. 13 depicts a perspective view of a portion of the electric vehicle of FIG. 1, according to an exemplary implementation.

FIG. 14 depicts an illustration of a process of providing a portion of an electric vehicle, according to an exemplary implementation.

FIG. 15 depicts a perspective view of a portion of the electric vehicle of FIG. 1, according to an exemplary implementation.

FIG. 16 depicts an illustration of a process of providing a portion of an electric vehicle, according to an exemplary implementation.

FIG. 17 depicts a rear view of a portion of the electric vehicle of FIG. 1, according to an exemplary implementation.

FIG. 18 depicts a rear perspective view of a portion of the electric vehicle of FIG. 1, according to an exemplary implementation.

FIG. 19 depicts an illustration of a process of providing a portion of an electric vehicle, according to an exemplary implementation.

### DETAILED DESCRIPTION

Following below are more detailed descriptions of various concepts related to, and implementations of, methods, apparatuses, and systems of electric vehicles. The various concepts introduced above and discussed in greater detail below may be implemented in any of numerous ways.

The present disclosure generally refers to an electric vehicle. The present disclosure refers generally to a tub of electric vehicle made at least partially via additive manufacturing processes.

Electric vehicle configurations are commonly used in various applications, such as commercial vehicles, motorsport vehicles, public transport, aviation, and the like. Generally, commercial electric vehicles are built with a body-on-frame architecture (e.g., skateboard chassis), as compared to a monocoque design (e.g., chassis and other components are all integrally formed into one body). Many motorsport vehicles utilize a monocoque design, but the manufacturing process can be time-consuming and expensive. Accordingly, it may be desirable for mass-manufactured electric vehicles, such as commercial vehicles, public transport vehicles, aviation, and the like, to have a monocoque design. The use of additive manufacturing may facilitate mass-manufacturing such electric vehicles.

Implementations described herein are directed to electric vehicles that include a carbon-fiber nylon, partially 3D printed, monocoque frame.

Implementations described herein are directed to electric vehicles that include a thermal management assembly formed with the tub to provide thermal regulation to a battery within the electric vehicle.

Implementations described herein are directed to electric vehicles that include a plurality of energy-absorbing impact zones for absorbing energy of impact.

Implementations described herein are directed to electric vehicles that include a wire harness assembly formed with the tub.

Implementations described herein are directed to electric vehicles that include a battery assembly formed with the tub.

Implementations described herein are directed to electric vehicles that include a sensor formed with the tub.

Implementations described herein are directed to electric vehicles that include a LIDAR sensor formed with the tub.

Generally, mass-produced vehicles do not utilize carbon-fiber materials for mass-production due to high labor costs, timing, and various other manufacturing challenges. Accordingly, it would be advantageous to provide a means for mass-producing vehicles using carbon fiber and, in particular, mass-producing electric vehicles using carbon fiber in additive manufacturing processes.

Referring generally to the figures, systems and methods herein are directed to providing a tub (e.g., a body) of an electric vehicle via additive manufacturing.

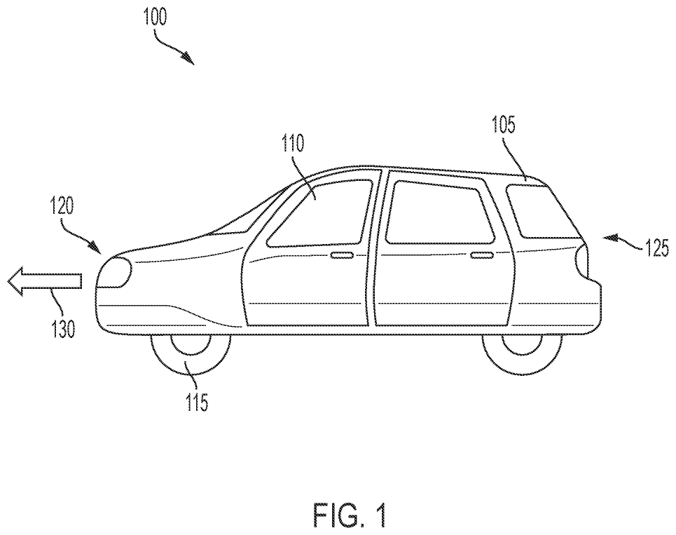

FIG. 1 depicts a schematic of an electric vehicle 100, according to an exemplary implementation. The electric vehicle 100 can be a general configuration of an electrically powered unit of transportation. For example, the electric vehicle 100 may be, but is not limited to, a car, electric vehicle, hybrid vehicle, internal combustion engine vehicle, motorcycle, scooter, a truck, a van, a bicycle, an aircraft, an airplane, a helicopter, a boat, or other various on-road or off-road vehicles. As shown in FIG. 1, the electric vehicle 100 can include a front end 120. For example, the front end 120 can be positioned at a front-most point of a forward direction of travel, depicted as arrow 130, when the electric vehicle 100 is operating under normal conditions. The electric vehicle 100 can include a rear end 125. For example, the rear end 125 can be positioned opposite the front end 120 when the vehicle 100 is moving in a forward direction of travel. The electric vehicle 100 can include one or more wheels 115. For example, the electric vehicle 100 can include two wheels 115. The electric vehicle 100 can include three wheels 115, as another example. The electric vehicle 100 can include four or more wheels 115, as yet another example. The electric vehicle 100 can include a commercial or personal vehicle for an end user consumer or member of the public. For example, the electric vehicle 100 can include seating capacity for four, five, or more adults and can include multiple front seats or multiple back seats, as well as storage space.

The electric vehicle 100 can include an operator cabin 110, shown as cabin 110. For example, the cabin 110 can include a space for accommodating occupants (e.g., users of the vehicle 100). The cabin 110 can include space for accommodating one occupant. The cabin 110 can include space for accommodating two occupants, as another example. The cabin 110 can include space for accommodating three or more occupants, as yet another example. The electric vehicle 100 can include a tub 105. For example, the tub 105 can include the framework, outer skin, or otherwise outer portion of the electric vehicle 100 at least partially visible to an outside user (e.g., a body of the vehicle 100).

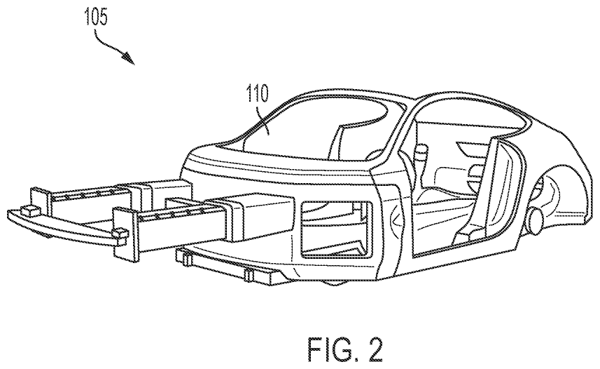

FIG. 2 depicts a perspective view of a portion of the tub 105, according to an exemplary implementation. As shown in FIG. 2, and among others, the tub 105 can include the framework of the electric vehicle 100 that surrounds the cabin 110. The tub 105 can provide support for the electric vehicle 100 and components within the electric vehicle 100. In various examples, tub 105 may not include various components of the vehicle 100 including, but not limited to, windows, windshields, wheels, and/or lights.

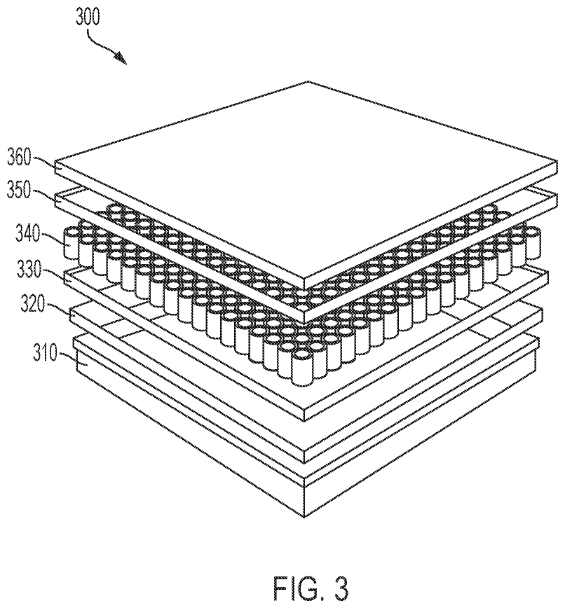

FIG. 3 depicts a perspective exploded view of a portion of the tub 105, according to an exemplary implementation. FIG. 3 depicts a composite structure 300. For example, the composite structure 300 can form a portion of the tub 105. The composite structure 300 can include several layers formed together (e.g., via stamping, welding, pressing, or another technique) to form a portion of the structure of the tub 105 (e.g., the exterior of the tub 105). For example, the tub 105 can be formed of the composite structure 300 to create a monocoque frame (e.g., a unibody). Each of the layers of the composite structure 300 described in greater detail below may be at least partially formed via additive manufacturing. For example, the composite structure 300 can include a shell 310. The shell 310 can be at least partially formed via additive manufacturing (e.g., 3D printing). For example, the shell 310 can be formed with additive manufacturing using a nylon filament. The nylon filament can include at least one carbon-fiber portion (e.g., mixed with and/or added to the nylon filament). For example, the nylon filament can include 0.01% carbon fiber. The nylon filament can include 10% carbon fiber, as another example. The nylon filament can include 20% carbon fiber, as yet another example. In various other examples, the nylon filament can include more than 20% carbon fiber. The shell 310 can be formed using various other plastics including, but not limited to ABS, PP, PVC, and/or PETE. The shell 310 can be formed using such various plastics in addition to the nylon filament and carbon fiber, in various examples. The shell 310 can be formed to various sizes (e.g., thicknesses) via additive manufacturing.

The composite structure 300 can include various other materials applied to the shell 310. For example, the composite structure 300 can include a first prepreg carbon-fiber layer 320. The first prepreg carbon-fiber layer 320 can include a carbon-fiber fabric that is impregnated with resin and/or various other agents. The first prepreg carbon-fiber layer 320 can be applied to the shell 310. For example, the first prepreg carbon-fiber layer 320 can be placed (e.g., added, set, printed, formed) on a top-side or underside portion of the shell 310 or another component of the composite structure 300 to be formed with the shell 310, as discussed in greater detail below.

The composite structure 300 can include a second prepreg carbon-fiber layer 360. For example, the second prepreg carbon-fiber layer 360 can include a carbon-fiber fabric that is impregnated with resin and/or various other agents. The second prepreg carbon-fiber layer 360 can be applied to the shell 310. For example, the second prepreg carbon-fiber layer 360 can be placed (e.g., added, set, printed, formed) on a top-side or underside portion of the shell 310 or another component of the composite structure 300 to be formed with the shell 310, as discussed in greater detail below.

The composite structure 300 can include various other materials applied to, printed with, or placed in between, the first prepreg carbon-fiber layer 320 and the second prepreg carbon-fiber layer 360. For example, the composite structure 300 can include a first epoxy layer 330. The first epoxy layer 330 (e.g., resins, solvents, acrylates, pure epoxy) can be applied to the first prepreg carbon-fiber layer 320 or another component of the composite structure 300 to be formed with the first prepreg carbon-fiber layer 320 and the shell 310, as discussed in greater detail below.

The composite structure 300 can include a nomex honeycomb layer 340. For example, the nomex honeycomb layer 340 can include a nonmetallic honeycomb material with a hexangular, cylindrical, rectangular, or similar cell shape. The nomex honeycomb layer 340 can be made of a flexible material. The nomex honeycomb layer 340 can be formed with the shell 310. For example, the nomex honeycomb layer 340 can be applied (e.g., set on top of, applied to) the first prepreg carbon-fiber layer 320, the epoxy layer 330, or another component of the composite structure 300 to be formed with the shell 310, as discussed in greater detail below. The nomex honeycomb layer 340 can be formed of varying size and thickness. For example, the nomex honeycomb layer 340 can have a thickness of about 5 millimeters. The nomex honeycomb layer 340 can have a thickness of about 12 millimeters, as another example. In various other examples, the nomex honeycomb layer 340 can be thicker or thinner than 12 millimeters.

The composite structure 300 can include a second epoxy later 350. For example, the second epoxy layer 350 (e.g., resins, solvents, acrylates, pure epoxy) can be applied to the nomex honeycomb layer 340 or another component of the composite structure 300 to be formed with the shell 310, as discussed in greater detail below.

Each component of the composite structure 300 can be formed together with the shell 310. For example, once each layer is added to the shell 310 either individually or together, the composite structure 300 can be formed (e.g., stamped, pressed, welded) such that pressure is placed on the composite structure 300 to form one singular structure. While the layers appear in one specific order in FIG. 3, in various other examples, the layers may be applied in various orders. For example, the first epoxy layer 330 may include several layers (e.g., coats) of epoxy material. The second epoxy layer 350 may include several layers (e.g., coats) of epoxy material. The second epoxy layer 350 may be applied to the second prepreg carbon-fiber layer 360, as another example. The composite structure 300 may not include certain components provided in FIG. 3, according to various other examples. According to one example, the composite structure 300 can be forged together. For example, the various components of the composite structure 300 may be hardened together under pressure. Various different materials can be used during the additive manufacturing processes to facilitate the hardening process including, but not limited to, ceramic materials. The composite structure 300 can include various additional or alternative materials to further facilitate improved performance of the vehicle 100. For example, the composite structure 300 can include at least one flame retardant material.

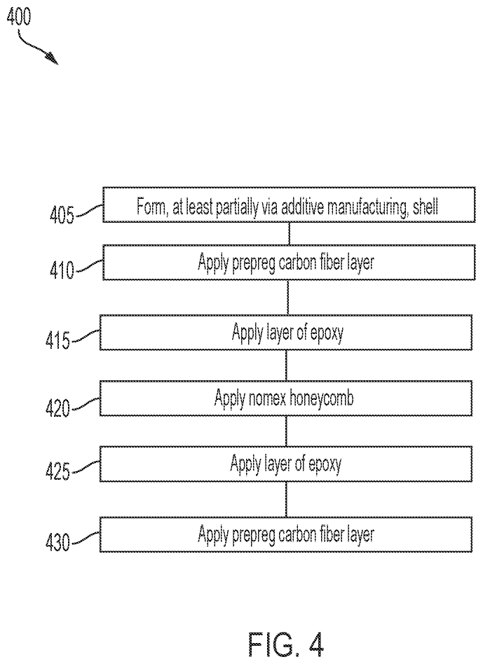

FIG. 4 depicts a method 400 of providing a tub 105 for an electric vehicle 100, according to an exemplary implementation. The method 400 can include forming, at least partially via additive manufacturing, a shell 310, as depicted in act 405. For example, the shell 310 can be formed with additive manufacturing using a nylon filament. The nylon filament can include at least one carbon-fiber portion (e.g., integrally mixed with the nylon filament). For example, the nylon filament can include 0.01% carbon fiber. The nylon filament can include 10% carbon fiber, as another example. The nylon filament can include 20% carbon fiber, as yet another example. In various other examples, the nylon filament can include more than 20% carbon fiber.

The method 400 can include applying a first prepreg carbon-fiber layer 320, as depicted in act 410. For example, the first prepreg carbon-fiber layer 320 can include a carbon-fiber fabric that is impregnated with resin and/or various other agents. The first prepreg carbon-fiber layer 320 can be applied to the shell 310. For example, the first prepreg carbon-fiber layer 320 can be placed (e.g., added, set, printed, formed) on a top-side or underside portion of the shell 310 or another component of the composite structure 300 to be formed with the shell 310.

The method 400 can include applying a first epoxy layer 330, as depicted in act 415. For example, the first epoxy layer 330 (e.g., resins, solvents, acrylates, pure epoxy) can be applied to the first prepreg carbon-fiber layer 320 or another component of the composite structure 300 to be formed with the first prepreg carbon-fiber layer 320 and the shell 310.

The method 400 can include applying a nomex honeycomb layer 340, as depicted in act 420. For example, the nomex honeycomb layer 340 can include a nonmetallic honeycomb material with a hexangular, cylindrical, rectangular, or similar cell shape. The nomex honeycomb layer 340 can be made of a flexible material. The nomex honeycomb layer 340 can be formed with the shell 310. For example, the nomex honeycomb layer 340 can be applied (e.g., set on top of, applied to, printed, formed) to the first prepreg carbon-fiber layer 320, the epoxy layer 330, or another component of the composite structure 300 to be formed with the shell 310.

The method 400 can include applying a second epoxy layer 350, as depicted in act 425. For example, the second epoxy layer 350 (e.g., resins, solvents, acrylates, pure epoxy) can be applied to the nomex honeycomb layer 340 or another component of the composite structure 300 to be formed with the shell 310.

The method 400 can include applying a second prepreg carbon-fiber layer 360, as depicted in act 430. For example, the second prepreg carbon-fiber layer 360 can include a carbon-fiber fabric that is impregnated with resin and/or various other agents. The second prepreg carbon-fiber layer 360 can be applied to the shell 310. For example, the second prepreg carbon-fiber layer 360 can be placed (e.g., added, set) on a top-side or underside portion of the shell 310 or another component of the composite structure 300 to be formed with the shell 310.

Generally, with vehicles including a body-on-frame configuration (e.g., chassis and fastened separate components), gaps between the vehicle body and other components, such as the battery, can lead to temperature differences between components during the lifespan of the vehicle. Accordingly, it would be advantageous to provide a battery assembly formed with a portion of the vehicle 100 to address the aforementioned challenges.

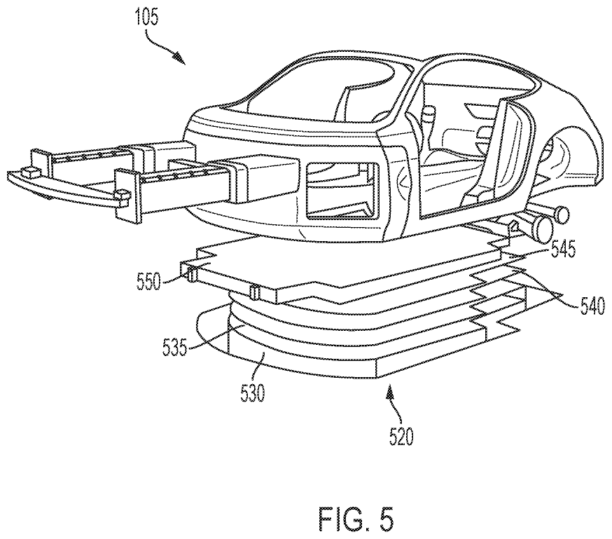

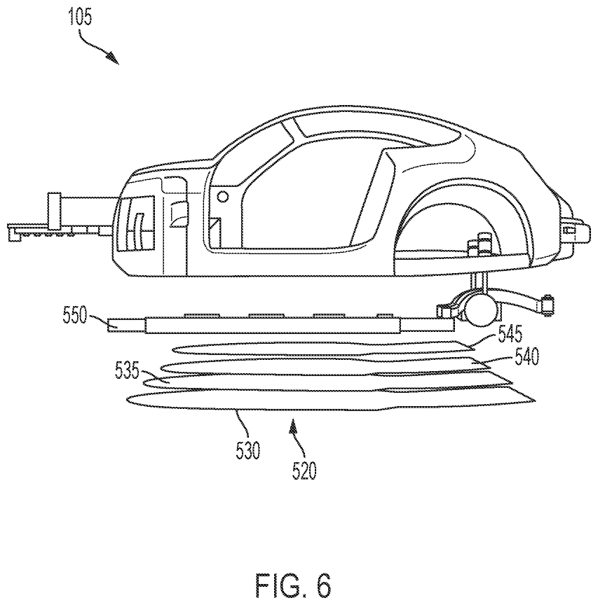

FIGS. 5 and 6 depict a perspective and side exploded view of a portion of the tub 105, according to an exemplary implementation. As shown in FIGS. 5 and 6, the tub 105 can include a thermal management assembly 520. For example, the thermal management assembly 520 can be formed with the tub 105. The thermal management assembly 520 can be formed with the tub 105 such that the tub 105 and the thermal management assembly 520 form one structure, according to one example. For example, the thermal management assembly 520 can be integrally formed with the tub 105 through additive manufacturing, welding, and/or stamping.

The thermal management assembly 520 can include a first carbon-fiber shield 530. The first carbon-fiber shield 530 can include at least one portion formed via additive manufacturing (e.g., 3D printing). For example, the first carbon-fiber shield 530 can be formed from a filament (e.g., nylon filament) that includes at least a portion of carbon fiber. For example, the first carbon-fiber shield 530 can include 0.01% carbon fiber. The first carbon-fiber shield 530 can include 10% carbon fiber, as another example. The first carbon-fiber shield 530 can include 20% or more carbon fiber, as yet another example. The first carbon-fiber shield 530 can include various other plastics including, but not limited to, ABS, PVS, PETE, and/or nylons. The first carbon-fiber shield 530 can vary in size and/or shape. For example, the first carbon-fiber shield 530 can have a thickness of about 0.75 millimeters. In other examples, the first carbon-fiber shield 530 can be thicker or thinner.

The thermal management assembly 520 can include a second carbon-fiber shield 545. The second carbon-fiber shield 545 can include at least one portion formed via additive manufacturing (e.g., 3D printing). For example, the second carbon-fiber shield 545 can be formed from a filament (e.g., nylon filament) that includes at least a portion of carbon fiber. For example, the second carbon-fiber shield 545 can include 0.01% carbon fiber. The second carbon-fiber shield 545 can include 10% carbon fiber, as another example. The second carbon-fiber shield 545 can include 20% or more carbon fiber, as yet another example. The second carbon-fiber shield 545 can include various other plastics including, but not limited to, ABS, PVS, PETE, and/or nylons. The second carbon-fiber shield 545 can vary in size and/or shape. For example, the second carbon-fiber shield 545 can have a thickness of about 0.75 millimeters. In other examples, the second carbon-fiber shield 545 can be thicker or thinner.

The thermal management assembly 520 can include various components positioned between the first carbon-fiber shield 530 and the second carbon-fiber shield 545. For example, the thermal management assembly 520 can include a thermal conductive layer 535. The thermal conductive layer 535 can include various metallic materials, such as copper, aluminum, or the like, to facilitate exchanging heat and conductivity within the thermal management assembly 520. According to the exemplary implementation depicted in FIGS. 5 and 6, the thermal conductive layer 535 is provided proximate the first carbon-fiber shield 530. In various other examples, the thermal conductive layer 535 may be provided proximate the second carbon-fiber shield 545 or another component of the thermal management assembly 520. The thermal conductive layer 535 can vary in size and/or shape. For example, the thermal conductive layer 535 can have a thickness of about 0.5 millimeters. In other examples, the thermal conductive layer 535 may be thicker or thinner. In various examples, the thermal conductive layer 535 may include varying shapes including, but not limited to, tubular, square, or a combination of unique shapes (e.g., to conform with various parts of the vehicle 100).

The thermal management assembly 520 can include an epoxy layer 540. For example, the epoxy layer 540 can include an epoxy material (e.g., resins, solvents, acrylates, pure epoxy) applied to the thermal conductive layer 535. According to the exemplary implementation depicted in FIGS. 5 and 6, the epoxy layer 540 is applied between the thermal conductive layer 535 and the second carbon-fiber shield 545. In various other examples, the epoxy layer 540 may be applied between the thermal conductive layer 535 and the first carbon-fiber shield 530. In various other examples, the thermal management assembly 520 may include a plurality of epoxy layers 540 (e.g., coats). In still yet other examples, the thermal management assembly 520 may not include an epoxy layer 540.

The thermal management assembly 520 can enclose a portion of a battery pack. For example, the thermal management assembly 520 can surround a flat-floor battery pack 550, as depicted in FIGS. 5 and 6. The thermal management assembly 520 can enclose the flat-floor battery pack 550 such that the thermal management assembly 520 can protect the flat-floor battery pack 550 from damage, such as debris, liquid, or other environmental conditions that could cause damage to the flat-floor battery pack 550. The thermal management assembly 520 can surround the flat-floor battery pack 550 such that the thermal management assembly 520 facilitates managing the thermal conditions of the flat-floor battery pack 550. The thermal management assembly 520 can facilitate protecting the flat-floor battery pack 550 from extreme climate conditions. For example, the thermal management assembly 520 can protect the flat-floor battery 550 from high temperature (e.g., by absorbing heat) or low temperatures (e.g., by maintaining heat). The thermal management assembly 520 can include one or more heat sinks coupled with the thermal management assembly 520 to facilitate managing the thermal conditions of the flat-floor battery pack 550. While the EV battery depicted in FIGS. 5 and 6 is a flat-floor battery pack 550, other examples may include various other EV battery pack configurations.

The thermal management assembly 520 can be formed with the tub 105 such that the thermal management assembly 520 is formed with the composite structure 300, according to various exemplary implementations. For example, the first carbon-fiber shield 530 may be partially formed with one or more components of the composite structure 300 such that the thermal management assembly 520 is integrally formed within the tub 105 (e.g., such that the tub 105 is one body). For example, the first carbon-fiber shield 530 may be integrally formed with the second prepreg carbon-fiber layer 360 of the composite structure 300. The first carbon-fiber shield 530 may be integrally formed with the shell 310 of the composite structure 300, as yet another example. The thermal management assembly 520 can be formed with the tub 105 such that no fluid or debris (e.g., dust, dirt, water) can flow into and/or enter the thermal management assembly 520 and cause damage to an internal portion of the electric vehicle 100. Accordingly, the thermal management assembly 520 can provide thermal management with limited risk of exposure to external elements.

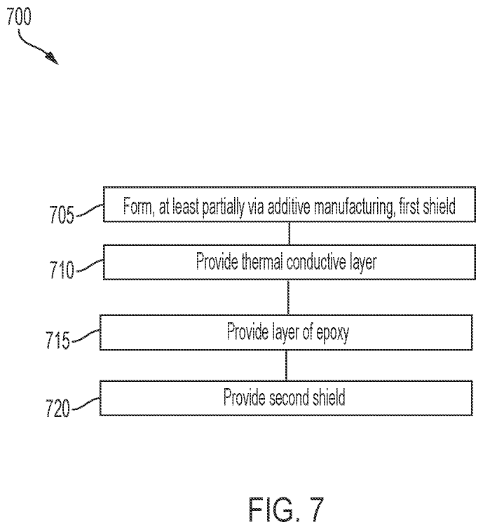

FIG. 7 depicts a method 700 of providing a tub 105 for an electric vehicle 100, according to an exemplary implementation. The method 700 can include forming, at least partially via additive manufacturing, a first carbon-fiber shield 530, as depicted in act 705. For example, the first carbon-fiber shield 530 can be formed from a filament (e.g., nylon filament) that includes at least a portion of carbon fiber. For example, the first carbon-fiber shield 530 can include 0.01% carbon fiber. The first carbon-fiber shield 530 can include 10% carbon fiber, as another example. The first carbon-fiber shield 530 can include 20% or more carbon fiber, as yet another example.

The method 700 can include providing a thermal conductive layer 535, as depicted in act 710. The thermal conductive layer 535 can include various metallic materials, such as copper, aluminum, or the like, to facilitate exchanging heat and conductivity within the thermal management assembly 520. According to the exemplary implementation depicted in FIGS. 5 and 6, the thermal conductive layer 535 is applied proximate the first carbon-fiber shield 530. In various other examples, the thermal conductive layer 535 may be applied proximate the second carbon-fiber shield 545 or another component of the thermal management assembly 520.

The method 700 can include providing an epoxy layer 540, as depicted in act 715. For example, the epoxy layer 540 can include an epoxy material (e.g., resins, solvents, acrylates, pure epoxy) applied to the thermal conductive layer 535. According to the exemplary implementation depicted in FIGS. 5 and 6, the epoxy layer 540 is applied between the thermal conductive layer 535 and the second carbon-fiber shield 545. In various other examples, the epoxy layer 540 may be applied between the thermal conductive layer 535 and the first carbon-fiber shield 530. In various other examples, the thermal management assembly 520 may include a plurality of epoxy layers 540. In still yet other examples, the thermal management assembly 520 may not include an epoxy layer 540.

The method 700 can include providing a second carbon-fiber shield 545, as depicted in act 720. For example, the second carbon-fiber shield 545 can be formed from a filament (e.g., nylon filament) that includes at least a portion of carbon fiber. For example, the second carbon-fiber shield 545 can include 0.01% carbon fiber. The second carbon-fiber shield 545 can include 10% carbon fiber, as another example. The second carbon-fiber shield 545 can include 20% or more carbon fiber, as yet another example.

Generally, typical vehicles made of aluminum, steel, or a similar metal, include “crumple” zones near the engine compartment that are designed to deform (e.g., buckle) upon impact to absorb energy and force of impact. These zones, however, are typically designed only for front-facing crashes (e.g., at the front end 120 of the vehicle 100). Accordingly, it would be advantageous to provide multiple energy-absorbing zones throughout the vehicle 100 for absorbing force of impact.

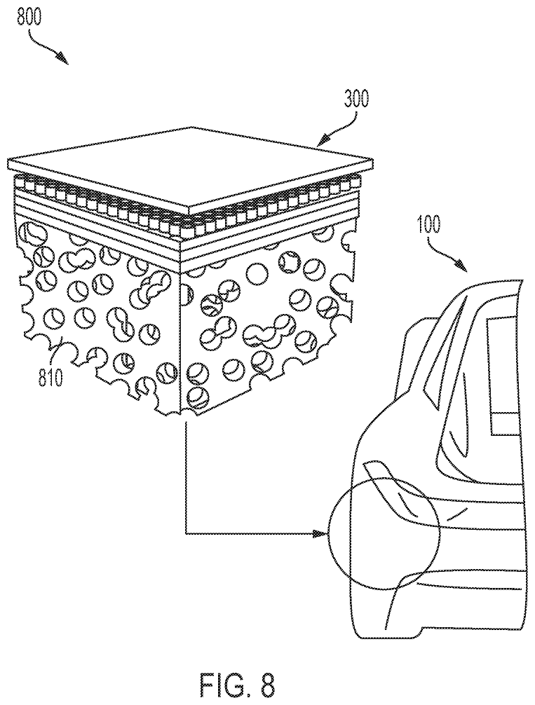

FIG. 8 depicts a perspective view of a portion of the tub 105, according to an exemplary implementation. FIG. 8 depicts an energy-absorbing impact assembly 800. For example, the energy-absorbing impact assembly 800 can include a matrix material structure 810. The matrix material structure 810 can facilitate absorbing energy of impact (e.g., crash, collision, contact with an object). For example, the matrix material structure 810 can include a honeycomb material with a generally hexagonal shape. The hexagonal shape can improve crash testing results. For example, the honeycomb material can be made from a mixture of filaments, elastomers, resins, or the like to provide elastomeric properties such that the matrix material structure 810 can dissipate energy (e.g., collapse, compress, or otherwise deform) in the event of a collision. For example, the honeycomb material can be made from various 3D printing filaments that include elastomeric properties such as thermoplastic polyurethane or thermoplastic elastomers.

The matrix material structure 810 can be formed with one or more components of the composite structure 300. For example, the matrix material structure 810 can be formed (e.g., via additive manufacturing, welding, stamping, pressing) with the shell 310 of the composite structure 300. In various other examples, the matrix material structure 810 can be formed with other components of the composite structure 300, such as the first prepreg carbon-fiber layer 320 or the second prepreg carbon-fiber layer 360. For example, the matrix material structure 810 can be formed with the shell 310 via a dual head extruder of an additive manufacturing process. Additional components of the composite structure 300 can similarly be formed simultaneously or separately with the shell 310 and the matrix material structure 810.

The energy-absorbing impact assembly 800 can be positioned at several locations throughout the electric vehicle 100. For example, the tub 105 can include one or more areas that include space (e.g., pockets, apertures) for the matrix material structure 810 to be added on an interior side of the electric vehicle 100 (e.g., positioned behind the second prepreg carbon-fiber layer 360). The tub 105 can include space positioned towards the front end 120 of the electric vehicle 100 for the matrix material structure 810. For example, the energy-absorbing impact assembly 800 can be located on a left-hand side of the front end 120 of the electric vehicle 100 (e.g., left-hand side of operator moving in a forward direction of travel). The energy-absorbing impact assembly 800 can be located on a right-hand side of the front end 120 of the electric vehicle 100 (e.g., right-hand side of operator moving in a forward direction of travel), as another example. The energy-absorbing impact assembly 800 can be located at a midpoint (e.g., center) of the front end 120 of the electric vehicle 100, as another example. In various other examples, the energy-absorbing impact assembly 800 can be located between the midpoint, the left-hand side, or the right-hand side of the front end 120 of the electric vehicle 100.

The tub 105 can include space positioned towards the rear end 125 of the electric vehicle 100 for the matrix material structure 810. For example, the energy-absorbing impact assembly 800 can be located on a left-hand side of the rear end 125 of the electric vehicle 100 (e.g., left-hand side of operator moving in a forward direction of travel). The energy-absorbing impact assembly 800 can be located on a right-hand side of the rear end 125 of the electric vehicle 100 (e.g., right-hand side of operator moving in a forward direction of travel), as another example. The energy-absorbing impact assembly 800 can be located at a midpoint (e.g., center) of the rear end 125 of the electric vehicle 100, as another example. In various other examples, the energy-absorbing impact assembly 800 can be located between the midpoint, the left-hand side, or the right-hand side of the rear end 125 of the electric vehicle 100.

The tub 105 can include space positioned on a side of the electric vehicle 100 for the matrix material structure 810. For example, the energy-absorbing impact assembly 800 can be located at various positions of a left-hand side of the electric vehicle 100 (e.g., left-hand side of operator moving in a forward direction of travel). The energy-absorbing impact assembly 800 can be located at various positions of a right-hand side of the electric vehicle 100 (e.g., right-hand side of operator moving in a forward direction of travel), as another example. For example, the energy-absorbing impact assembly 800 can be located at any exterior position that surrounds the operator cabin 110 to absorb energy of impact.

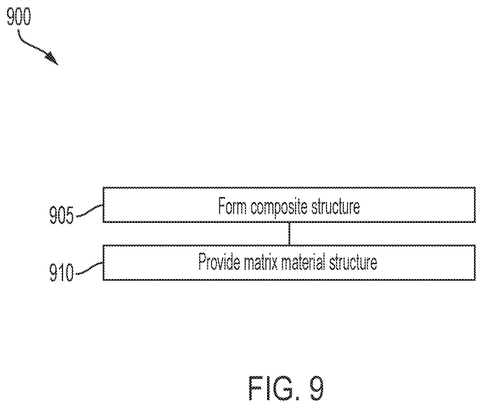

FIG. 9 depicts a method 900 of providing a tub 105 for an electric vehicle 100, according to an exemplary implementation. The method 900 can include forming composite structure 300, as depicted in act 905. For example, the composite structure 300 can include a 3D printed shell 310 made at least partially via additive manufacturing using carbon-fiber nylon filament and/or various other plastics. The composite structure 300 can include various other materials formed with the shell 310 including epoxy, prepreg carbon fiber, and/or nomex honeycomb. For example, the materials can be stamped, welded, or pressed with the shell 310 to create the composite structure 300.

The method 900 can include providing a matrix material structure 810, as depicted in act 910. For example, the matrix material structure 810 can be formed (e.g., welded, stamped, pressed, printed) with one or more components of the composite structure 300 at various locations of the electric vehicle 100 including the front end 120, the rear end 125, and either side between the front end 120 and rear end 125. The matrix material structure 810 can facilitate absorbing energy of impact of the electric vehicle 100 (e.g., a crash, collision, contact with an object). For example, the matrix material structure 810 can include a honeycomb material. The honeycomb material can be made from a mixture of filaments, elastomers, resins, or the like to provide elastomeric properties such that the matrix material structure 810 can dissipate energy (e.g., collapse, compress, or otherwise deform) in the event of a collision.

Generally, typical electric vehicles include one or more wire harnesses. For example, wire harnesses can include an assembly of electric cables, wires, or the like, which can transmit signals, electrical power, and/or current from one portion of the vehicle to another. Typical wire harnesses can cause additional manufacturing and packaging challenges and potentially lead to increased cabin noise (e.g., vibrations of cables) and additional weight added to the vehicle. Accordingly, it would be advantageous to provide a wire harness assembly that is formed directly with a portion of the electric vehicle 100 to address the aforementioned challenges.

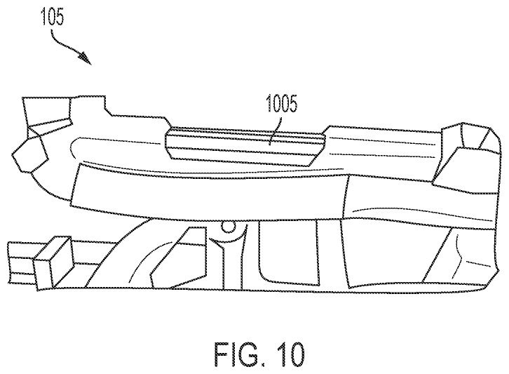

FIG. 10 depicts a side view of a portion of the tub 105, according to an exemplary implementation. FIG. 10 depicts a portion of a wire harness assembly 1005 formed with the tub 105. For example, the wire harness assembly 1005 can be formed with one or more components of the composite structure 300 of the tub 105 through additive manufacturing (e.g., 3D printing). In various examples, at least a portion of the wire harness assembly 1005 can be formed with the composite structure 300 of the tub 105 such that the wire harness is integral (e.g., attached, fixed) with a portion of the tub 105. For example, the wire harness assembly 1005 can be formed with the tub 105 during the printing stage of 3D printing (e.g., during 3D printing of the shell 310), such that the wire harness assembly 1005 is integrally formed with the tub 105. A portion of the wire harness assembly 1005 (e.g., cables) can be formed with one or more components of the composite structure 300 of the tub 105 during additive manufacturing. Throughout the process of manufacturing, the portion of the wire harness assembly 1005 may be adjusted to conform to various shapes and configurations of the wire harness assembly 1005. For example, various cables of the wire harness assembly 1005 can be formed along the tub 105 via various extrusion processes of additive manufacturing including, but not limited to, quad extrusion. Various manufacturing systems, such as 3D printers, may include different extrusion heads each producing a different portion of the wire harness assembly 1005 (e.g., wiring, insulation).

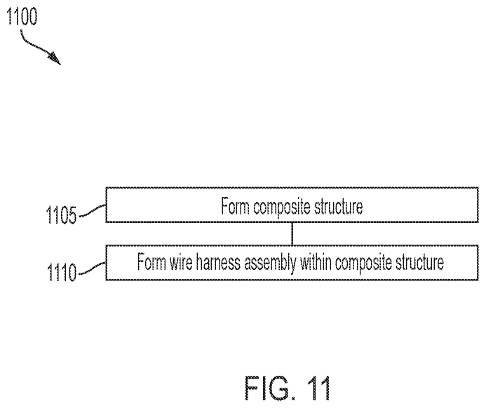

FIG. 11 depicts of method 1100 of providing a tub 105 for an electric vehicle 100. The method 1100 can forming composite structure 300, as depicted in act 1105. For example, the composite structure 300 can include a 3D printed shell 310 made at least partially via additive manufacturing using carbon-fiber nylon filament and/or various other plastics. The composite structure 300 can include various other materials formed with the shell 310 including epoxy, prepreg carbon fiber, and/or nomex honeycomb. For example, the materials can be stamped, welded, or pressed with the shell 310 to create the composite structure 300.

The method 1100 can include forming a portion of a wire harness assembly 1005 within the composite structure 300, as depicted in act 1110. For example, a portion of the wire harness assembly 1005 can be formed with one or more components of the composite structure 300 such that the wire harness assembly 1005 is integrally formed with a portion of the tub 105 (e.g., attached, fixed).

Generally, typical electric vehicles include one or more battery packs. For example, many electric vehicles include a battery pack that is separate from the vehicle and is integrated into a predetermined space post-manufacturing. Such configurations may lead to complex packaging challenges, limited spacing, and/or various other manufacturing challenges. Accordingly, it would be advantageous to provide a battery assembly that is formed directly with a portion of the electric vehicle 100 to address the aforementioned challenges.

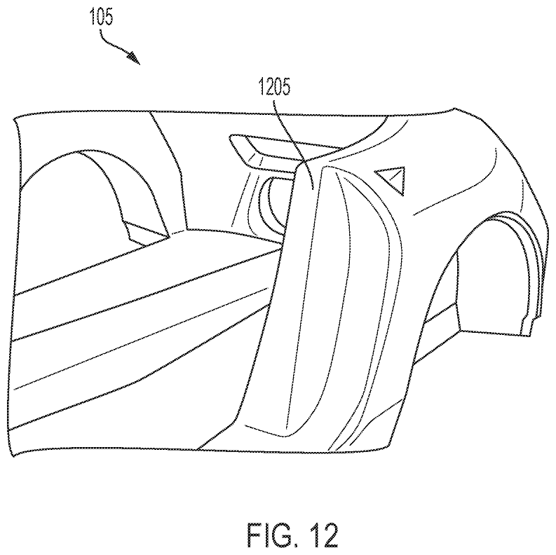

FIG. 12 depicts a perspective view of a portion of the tub 105, according to an exemplary implementation. As shown in FIG. 12, the tub 105 can include a space for a battery pack assembly 1205 to be formed within the tub 105. For example, during additive manufacturing of one or more components of the composite structure 300 of the tub 105 (e.g., the shell 310, the first prepreg carbon-fiber layer 320, the second prepreg carbon-fiber layer 360), the battery pack assembly 1205 can be added to the composite structure 300 such that the battery pack assembly 1205 is embedded into a portion of the tub 105. By way of example, once the shell 310 is formed (e.g., via 3D printing), one or more prepreg carbon fiber layers (e.g., the second prepreg carbon-fiber layer 360) may be applied to the shell 310 surrounding the battery pack assembly 1205. The battery pack assembly 1205 and one or more carbon fiber layers can be formed (e.g., stamped, pressed, welded) together such that the battery pack assembly 1205 is integrally formed with the composite structure 300 of the tub 105. In various examples, the battery pack assembly 1205 can replace a component of the composite structure 300 of the tub 105. For example, the battery pack assembly 1205 can be formed with the composite structure 300 such that the battery pack assembly 1205 replaces a portion of the nomex honeycomb layer 340. The battery pack assembly 1205 can be formed with the composite structure 300 such that the battery pack assembly 1205 replaces a portion of various other components of the composite structure 300, as another example.

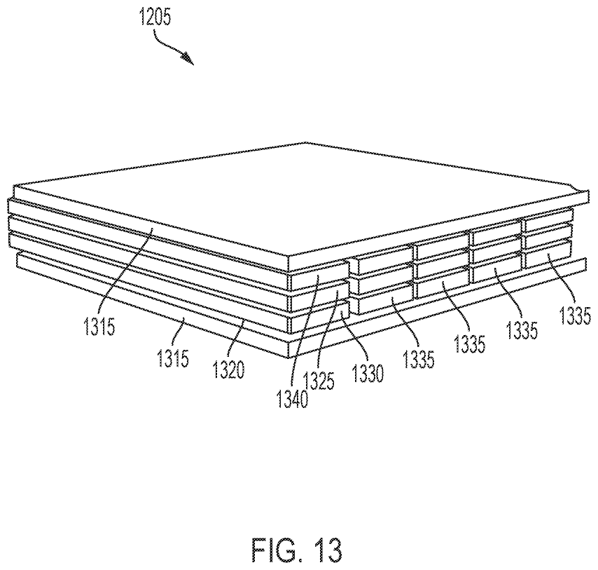

FIG. 13 depicts an example of the battery pack assembly 1205 formed within the tub 105. For example, the battery pack assembly 1205 can be or can include a stand-alone battery pack. The battery pack assembly 1205, or one or more components of the battery pack assembly 1205, can be made from carbon fiber. As shown in FIG. 13, the battery pack assembly 1205 can include a battery membrane 1320. For example, the battery membrane 1320 can include a material to facilitate separating the one or more battery cells 1335 within the battery pack assembly 1205 from one another. The battery membrane 1320 can be made from various materials including, but not limited to, polymers, resins, plastics, elastomers, and/or metals. The battery membrane 1320 can facilitate forming the battery cells 1335 with the composite structure 300 of the tub 105. For example, the battery pack assembly 1205 can include one or more carbon fiber layers 1315 surrounding the battery pack assembly 1205. The carbon fiber layers 1315 can be integrally formed with and/or be a part of one or more components of the composite structure 300.

The battery pack assembly 1205 can be embedded into the composite structure 300 of the tub 105 such that the battery pack assembly 1205 is not exposed to the exterior of the electric vehicle 100. For example, the battery pack assembly 1205 may be embedded in between the shell 310 and the second prepreg carbon-fiber layer 360 of the composite structure 300. The battery pack assembly 1205 may be embedded into the tub 105 such that the battery pack assembly 1205 is not exposed to environmental and exterior climate conditions such as fluid, dirt, or other debris. The battery pack assembly 1205 can allow for a more customizable battery pack solution (e.g., compared to conventional battery packs) with more efficient manufacturing and packaging.

As shown in FIG. 13, the battery pack assembly 1205 can include an anode 1340, a cathode 1330, and/or an electrolyte 1325. For example, the anode 1340 can include a negative electrode for releasing electrons within the battery cells 1335. The cathode 1330 can include a positive electrode that acquires electrons within the battery cells 1335. The electrolyte 1325 may be the medium that provides ion transport mechanisms between the cathode 1330 and the anode 1340 of the battery cells 1335. In various examples, the battery pack assembly 1205 may include various other components to facilitate providing electric power to the electric vehicle 100. While the exemplary implementation depicted in FIGS. 12 and 13 includes a battery pack assembly 1205 in one particular configuration, various other battery configurations may be includes in various other examples.

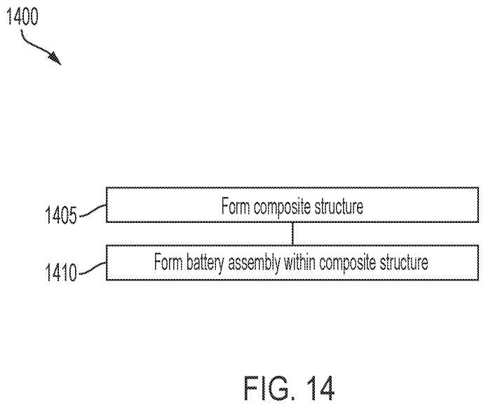

FIG. 14 depicts a method 1400 of providing a tub 105 for an electric vehicle 100. The method 1400 can include forming composite structure 300, as depicted in act 1405. For example, the composite structure 300 can include a 3D printed shell 310 made at least partially via additive manufacturing using carbon-fiber nylon filament and/or various other plastics. The composite structure 300 can include various other materials formed with the shell 310 including epoxy, prepreg carbon fiber, and/or nomex honeycomb. For example, the materials can be stamped, welded, or pressed with the shell 310 to create the composite structure 300.

The method 1400 can include forming a battery pack assembly 1205 within the composite structure 300, as depicted in act 1410. For example, the battery pack assembly 1205 can be formed with one or more components of the composite structure 300 such that the battery pack assembly 1205 is integrally formed with a portion of the tub 105 (e.g., fixed, embedded). For example, during additive manufacturing of one or more components of the composite structure 300 of the tub 105 (e.g., the shell 310, the first prepreg carbon-fiber layer 320, the second prepreg carbon-fiber layer 360), the battery pack assembly 1205 can be added to the composite structure 300 such that the battery pack assembly 1205 is embedded into a portion of the tub 105. By way of example, once the shell 310 is formed (e.g., via 3D printing), one or more prepreg carbon fiber layers (e.g., the second prepreg carbon-fiber layer 360) may be applied to the shell 310 surrounding the battery pack assembly 1205. The battery pack assembly 1205 and one or more carbon fiber layers can be formed (e.g., stamped, pressed, welded) together such that the battery pack assembly 1205 is integrally formed with the composite structure 300 of the tub 105.

Generally, carbon fiber has been used as a material for motorsport (e.g., racing) vehicles. However, due to lack of use in typical commercial vehicles and other mass produced vehicles, carbon fiber has rarely been tested for long-term usage. Accordingly, it would be advantageous to provide a means for predicting a physical state of carbon fiber within a vehicle over time.

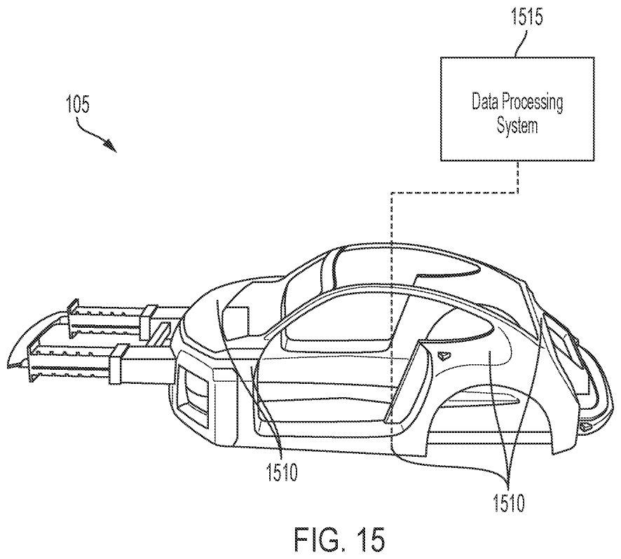

FIG. 15 depicts a perspective side view of a portion of a tub 105, according to an exemplary implementation. As shown in FIG. 15, the tub 105 can include one or more sensors 1510 formed with the tub 105. In various examples, the sensors 1510 can be embedded into the tub 105 during manufacturing. For example, the sensors 1510 can be embedded into one or more components of the composite structure 300, such as the 3D printed shell 310, of the tub 105 during additive manufacturing (e.g., during 3D printing).

The embedded sensors 1510 can include one or more components to detect a mechanical stress and/or strain value of the tub 105. For example, the sensors 1510 may include one or more strain gauges embedded with a portion of the carbon fiber material within the tub 105 (e.g., within the composite structure 300). The sensors 1510 can be or can include a temperature sensor, an accelerometer, a pressure sensor, or another type of sensor. The sensors can create the ability to improve the driving performance of the vehicle 100 by leveraging inputting sensor data into an active suspension system for an improved driver experience. The sensors 1510 may be able to detect strain at various locations of the tub 105. The sensors 1510 may communicably couple with a data processing system 1515. For example, the sensors 1510 may be able to send one or more signals to the data processing system 1515 to process the signals. In various examples, the data processing system 1515 may be internal to the vehicle 100. For example, the data processing system 1515 may be incorporated into a computing system for the electric vehicle 100. The data processing system 1515 may be incorporated or a component of an application-specific integrated circuit (ASIC) for the vehicle 100. In some examples, the data processing system 1515 may be external to and communicably coupled (e.g., via various application programming interfaces (APIs)) to the vehicle 100. The data processing system 1515 may be include various processors to calculate, based on the signals, a mechanical stress value of a location of the tub 105.

In various examples, the sensors 1510 may be embedded into the tub 105 such that the sensors 1510 are not exposed to the exterior of the tub 105 and/or the vehicle 100. For example, in some examples, the sensors 1510 may be formed with (printed into, molded, welded) the composite structure 300 of the tub 105 such that the sensor 1510 is not exposed to the environment surrounded the vehicle 100. In other examples, the sensors 1510 may be embedded into the tub 105 such that one or more portions of the sensors 1510 are exposed to the exterior of the tub 105 and/or the vehicle 100. For example, in some examples, the sensors 1510 may be formed with (printed into, molded, welded) the composite structure 300 of the tub 105 such that the sensor 1510 is exposed to the environment surrounded the vehicle 100. In various examples, the sensors 1510 may include one or more components to facilitate protecting the sensors 1510 from damage, such as a cover (e.g., cap, seal).

In various examples, the electric vehicle 100 may include several sensors 1510 positioned at various locations throughout the vehicle 100. For example, the electric vehicle 100 may include one sensor 1510. The electric vehicle 100 may include two sensors 1510, as another example. The electric vehicle 100 may include three or more sensors 1510, as yet another example. The sensors 1510 may be positioned at the front end 120 of the vehicle 100. The sensors 1510 may be positioned at the rear end 125 of the vehicle 100, as another example. The sensors 1510 may be positioned on an underside or topside of the vehicle 100, according to one example. The sensors 1510 may be positioned on a left-hand or right-hand side of the vehicle 100, as another example.

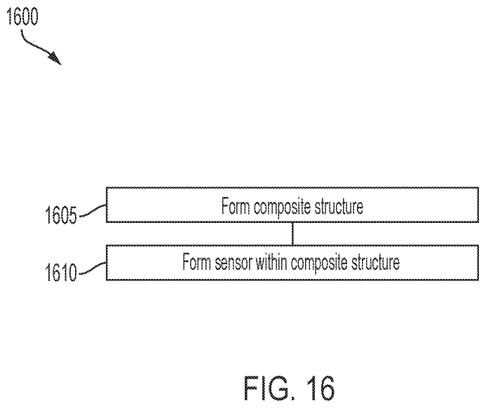

FIG. 16 depicts a method 1600 of providing a tub 105 of an electric vehicle 100, according to an exemplary implementation. The method 1600 can include forming, at least partially via additive manufacturing, a composite structure 300, as depicted in act 1605. For example, the composite structure 300 can include a 3D printed shell 310 made at least partially via additive manufacturing using carbon-fiber nylon filament and/or various other plastics. The composite structure 300 can include various other materials formed with the shell 310 including epoxy, prepreg carbon fiber, and/or nomex honeycomb. For example, the materials can be stamped, welded, or pressed with the shell 310 to create the composite structure 300.

The method 1600 can include forming a sensor 1510 within the composite structure 300, as depicted in act 1610. For example, the sensors 1510 can be embedded into the tub 105 during manufacturing. The sensors 1510 can be embedded into one or more components of the composite structure 300, such as the 3D printed shell 310, of the tub 105 during additive manufacturing (e.g., during 3D printing). In various examples, the sensors 1510 may be embedded into the tub 105 such that the sensors 1510 are not exposed to the exterior of the tub 105 and/or the vehicle 100. For example, in some examples, the sensors 1510 may be formed with (printed into, molded, welded) the composite structure 300 of the tub 105 such that the sensor 1510 is not exposed to the environment surrounded the vehicle 100. In other examples, the sensors 1510 may be embedded into the tub 105 such that one or more portions of the sensors 1510 are exposed to the exterior of the tub 105 and/or the vehicle 100. For example, in some examples, the sensors 1510 may be formed with (printed into, molded, welded) the composite structure 300 of the tub 105 such that the sensor 1510 is exposed to the environment surrounded the vehicle 100. In various examples, the sensors 1510 may include one or more components to facilitate protecting the sensors 1510 from damage, such as a cover (e.g., cap, seal).

Generally, in various types of vehicles, one or more LIDAR sensors or radars may be installed into a framework of the vehicle using subtractive manufacturing methods (e.g., machining). Furthermore, many typical LIDAR sensors may be attached to a top-side portion of a vehicle, creating aesthetic and aerodynamic challenges. Accordingly, it would be advantageous to provide a LIDAR sensor formed with a portion of the electric vehicle 100.

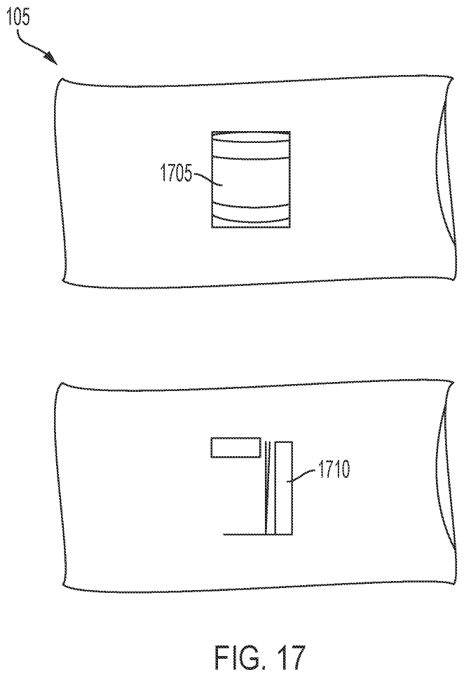

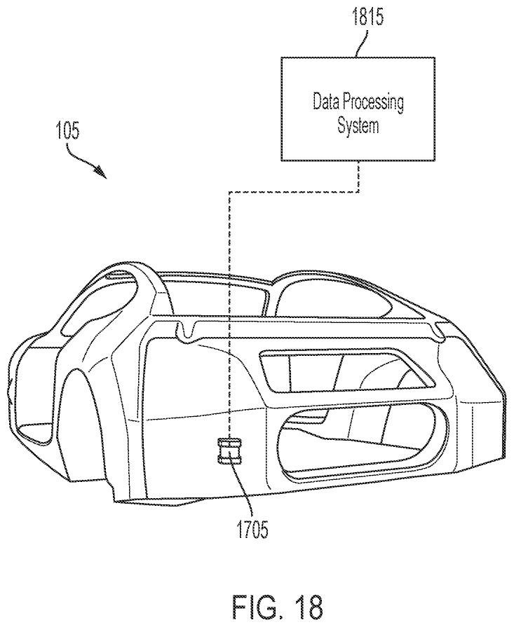

FIG. 17 depicts a rear view of a portion of the tub 105, according to an exemplary implementation. As shown in FIG. 17, and as well in FIG. 18, a LIDAR sensor 1705 may be formed with a portion of the tub 105. In various examples, the LIDAR sensor 1705 can be embedded into the tub 105 during manufacturing. For example, the LIDAR sensor 1705 can be embedded into one or more components of the composite structure 300, such as the 3D printed shell 310, of the tub 105 during additive manufacturing (e.g., during 3D printing). As shown in FIG. 17, the tub 105 can be formed to include a retaining pocket 1710 within the tub 105 to enclose, or fix the LIDAR sensor 1705 to the tub 105. For example, the retaining pocket 1710 can be formed (e.g., printed) into one or more components of the composite structure 300 during additive manufacturing.

In various examples, the LIDAR sensor 1705 may be embedded into the tub 105 such that the LIDAR sensor 1705 is not exposed to the exterior of the tub 105 and/or the vehicle 100. For example, in some examples, the LIDAR sensor 1705 may be formed with (printed into, molded, welded) the composite structure 300 of the tub 105 such that the LIDAR sensor 1705 is not exposed to the environment surrounded the vehicle 100. In other examples, the LIDAR sensor 1705 may be embedded into the tub 105 such that one or more portions of the LIDAR sensor 1705 are exposed to the exterior of the tub 105 and/or the vehicle 100. For example, in some examples, the LIDAR sensor 1705 may be formed with (printed into, molded, welded) the composite structure 300 of the tub 105 such that the LIDAR sensor 1705 is exposed to the environment surrounded the vehicle 100. In various examples, the LIDAR sensor 1705 may include one or more components to facilitate protecting the LIDAR sensor 1705 from damage, such as a cover (e.g., cap, seal).

In various examples, the electric vehicle 100 may include several LIDAR sensors 1705 positioned at various locations throughout the vehicle 100. For example, the electric vehicle 100 may include one LIDAR sensor 1705. The electric vehicle 100 may include two LIDAR sensors 1705, as another example. The electric vehicle 100 may include three or more LIDAR sensors 1705, as yet another example. The LIDAR sensors 1705 may be positioned at the front end 120 of the vehicle 100. The LIDAR sensors 1705 may be positioned at the rear end 125 of the vehicle 100, as another example. The LIDAR sensors 1705 may be positioned on an underside or topside of the vehicle 100, according to one example. The LIDAR sensors 1705 may be positioned on a left-hand or right-hand side of the vehicle 100, as another example.

FIG. 18 depicts a rear perspective view of a portion of the tub 105, according to an exemplary implementation. The embedded LIDAR sensor 1705 can include one or more for determining a range (e.g., variable distance) of an object relative to the electric vehicle 100. The LIDAR sensor 1705 may communicably couple with a data processing system 1815. For example, the LIDAR sensor 1705 may be able to send one or more signals to the data processing system 1815 to process the signals. In various examples, the data processing system 1815, which can include data processing system 1515, may be internal to the vehicle 100. For example, the data processing system 1815 may be incorporated into a computing system for the electric vehicle 100. The data processing system 1815 may be incorporated or a component of an application-specific integrated circuit (ASIC) for the vehicle 100. In some examples, the data processing system 1815 may be external to and communicably coupled (e.g., via various application programming interfaces (APIs)) to the vehicle 100. The data processing system 1815 may be include various processors to calculate, based on the signals, a variable distance of an object relative to the vehicle 100.

In various examples, the tub 105 can include one or more sound emission sensors (such as sensors 1510) embedded within the tub 105. For example, the sound emission sensors can be operably coupled with the one or more LIDAR sensors 1705 and/or the data processing system 1815 to facilitate detecting various objects relative to the vehicle. The electric vehicle 100 may include various sensors 1510 including, but not limited to, LIDAR sensors 1705, sound emission sensors, stress/strain sensors, IR sensors, UV sensors, light sensors, and/or temperature sensors.

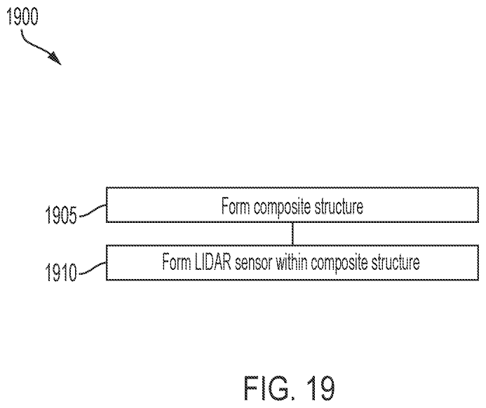

FIG. 19 depicts a method 1900 of providing a tub 105 for an electric vehicle 100. The method 1900 can include forming, at least partially via additive manufacturing, a composite structure 300, as depicted in act 1905. For example, the composite structure 300 can include a 3D printed shell 310 made at least partially via additive manufacturing using carbon-fiber nylon filament and/or various other plastics. The composite structure 300 can include various other materials formed with the shell 310 including epoxy, prepreg carbon fiber, and/or nomex honeycomb. For example, the materials can be stamped, welded, or pressed with the shell 310 to create the composite structure 300.

The method 1900 can include forming a LIDAR sensor 1705 within the composite structure 300, as depicted in act 1910. For example, the LIDAR sensor 1705 can be embedded into the tub 105 during manufacturing. The LIDAR sensor 1705 can be embedded into one or more components of the composite structure 300, such as the 3D printed shell 310, of the tub 105 during additive manufacturing (e.g., during 3D printing). As shown in FIG. 17, the tub 105 can be formed to include a retaining pocket 1710 within the tub 105 to enclose, or fix the LIDAR sensor 1705 to the tub 105. For example, the retaining pocket 1710 can be formed (e.g., printed) into one or more components of the composite structure 300 during additive manufacturing.

In various examples, the LIDAR sensor 1705 may be embedded into the tub 105 such that the LIDAR sensor 1705 is not exposed to the exterior of the tub 105 and/or the vehicle 100. For example, in some examples, the LIDAR sensor 1705 may be formed with (printed into, molded, welded) the composite structure 300 of the tub 105 such that the LIDAR sensor 1705 is not exposed to the environment surrounded the vehicle 100. In other examples, the LIDAR sensor 1705 may be embedded into the tub 105 such that one or more portions of the LIDAR sensor 1705 are exposed to the exterior of the tub 105 and/or the vehicle 100. For example, in some examples, the LIDAR sensor 1705 may be formed with (printed into, molded, welded) the composite structure 300 of the tub 105 such that the LIDAR sensor 1705 is exposed to the environment surrounded the vehicle 100. In various examples, the LIDAR sensor 1705 may include one or more components to facilitate protecting the LIDAR sensor 1705 from damage, such as a cover (e.g., cap, seal).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The hardware and data processing components (such as the data processing system 1515) used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The construction and arrangement of the electric vehicle as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, other elements of the various embodiments may be incorporated or utilized with any of the other embodiments disclosed herein.

1. A tub of an electric vehicle, the tub comprising:
a composite structure, the composite structure including:
a 3D-printed shell, the shell including at least one portion of a carbon-fiber nylon filament;
a first prepreg carbon fiber layer coupled with the shell;
at least one layer of an epoxy material coupled with the shell;
a nomex honeycomb material coupled with the shell; and
a second prepreg carbon fiber layer coupled with the shell.

2. The tub of claim 1, comprising:
the first prepreg carbon fiber layer, the at least one layer of an epoxy material, the nomex honeycomb material, and the second prepreg carbon fiber layer to be pressed together to form one singular structure.

3. The tub of claim 1, comprising:
the first prepreg carbon fiber layer includes a carbon-fiber fabric impregnated with resin; and
the second prepreg carbon fiber layer includes a carbon-fiber fabric impregnated with resin.

4. The tub of claim 1, comprising:
the first prepreg carbon fiber layer to be printed on an underside portion of the 3D-printed shell; and
the second prepreg carbon fiber layer to be printed on a top side portion of the 3D-printed shell.

5. The tub of claim 1, comprising:
a first layer of the epoxy material disposed between the first prepreg carbon fiber layer and the nomex honeycomb material; and
a second layer of the epoxy material disposed between the second prepreg carbon fiber layer and the nomex honeycomb material.

6. The tub of claim 1, comprising:
the nomex honeycomb material having a thickness between 5 millimeters and 12 millimeters.

7. The tub of claim 1, comprising:
the composite structure to form a portion of a monocoque frame.

8. A method of providing a tub of an electric vehicle, the method comprising:
forming, at least partially via additive manufacturing, a carbon-fiber nylon filament shell;
applying a first prepreg carbon fiber layer to the shell;
applying a first layer of an epoxy material;
applying a nomex honeycomb material to the shell;
applying a second layer of an epoxy material; and
applying a second prepreg carbon fiber layer to the shell.

9. The method of claim 8, comprising:
forming, at least partially via additive manufacturing, the second prepreg carbon fiber layer.

10. The method of claim 8, comprising:
pressing the first prepreg carbon fiber layer, the first layer an epoxy material, the nomex honeycomb material, and the second prepreg carbon fiber layer together to form one singular structure.

11. The method of claim 8, comprising:
the first prepreg carbon fiber layer includes a carbon-fiber fabric impregnated with resin; and
the second prepreg carbon fiber layer includes a carbon-fiber fabric impregnated with resin.

12. The method of claim 8, comprising:
printing the first prepreg carbon fiber layer on an underside portion of the shell; and
printing the second prepreg carbon fiber layer on a top side portion of the shell.

13. The method of claim 8, comprising:
disposing the first layer of the epoxy material between the first prepreg carbon fiber layer and the nomex honeycomb material; and
disposing the second layer of the epoxy material between the second prepreg carbon fiber layer and the nomex honeycomb material.

14. The method of claim 8, comprising:
the nomex honeycomb material having a thickness between 5 millimeters and 12 millimeters.

15. The method of claim 8, comprising:
the tub to form a portion of a monocoque frame having a composite structure.

16. An electric vehicle, comprising:
a tub, including:
a composite structure, the composite structure including:
a 3D-printed shell, the shell including at least one portion of a carbon-fiber nylon filament;
a first prepreg carbon fiber layer coupled with the shell;
at least one layer of an epoxy material coupled with the shell;
a nomex honeycomb material coupled with the shell; and
a second prepreg carbon fiber layer coupled with the shell.

17. The electric vehicle of claim 16, comprising:
the tub to accommodate at least four occupants.

18. The electric vehicle of claim 16, comprising:
the first prepreg carbon fiber layer, the at least one layer of an epoxy material, the nomex honeycomb material, and the second prepreg carbon fiber layer to be pressed together to form one singular structure.

19. The electric vehicle of claim 16, comprising:
the tub to form a portion of a monocoque frame for the electric vehicle.

20. The electric vehicle of claim 16, comprising:
the first prepreg carbon fiber layer to be printed on an underside portion of the 3D-printed shell; and
the second prepreg carbon fiber layer to be printed on a top side portion of the 3D-printed shell.

21.-68. (canceled)
